(19) United States
(12) Patent Application Publication
(10) Pub. No.: US 2025/0131467 A1
(43) Pub. Date: Apr. 24, 2025

(54) SPORTING EVENT WAGERING SYSTEM OPERABLE WITH RETAIL SYSTEM TO OFFER BENEFITS

(71) Applicant: IGT, Las Vegas, NV (US)

(72) Inventors: Dwayne Nelson, Las Vegas, NV (US); Kevin Higgins, Reno, NV (US)

(21) Appl. No.: 18/383,348

(22) Filed: Oct. 24, 2023

(51) Int. Cl. G06Q 30/0238; G06Q 30/0226; G06Q 50/34

(52) U.S. Cl. CPC G06Q 30/0238; G06Q 30/0233; G06Q 50/34

(57) ABSTRACT

Systems and methods that enable retail benefits for sporting event wagering activity occurring at a retail establishment independent of any casino location.

### BACKGROUND

In various embodiments, the systems and methods of the present disclosure enable retail benefits for sporting event wagering activity occurring at a retail establishment independent of any casino location.

Sports betting terminals in casino locations may enable a player to place a sporting event wager predicting the results of a sporting event.

### BRIEF SUMMARY

In certain embodiments, the present disclosure relates to a system including a processor, and a memory device that stores a plurality of instructions. When executed by the processor responsive to a receipt of data for a purchase transaction initiated at a point-of-sale terminal associated with a retail establishment that is independent of any gaming establishment and responsive to a determination to authorize the purchase transaction based on an application of a first benefit earned from a first amount of sporting event wagering activity that occurred at the retail establishment, the instructions cause the processor to designate the first benefit as at least partially redeemed, and notify the point-of-sale terminal to complete the purchase transaction without any additional forms of payment. When executed by the processor responsive to the receipt of data for the purchase transaction initiated at the point-of-sale terminal associated with the retail establishment that is independent of any gaming establishment and responsive to a determination to authorize part of the purchase transaction based on an application of a second benefit earned from a second amount of sporting event wagering activity that occurred at the retail establishment, the instructions cause the processor to designate the second benefit as redeemed, and notify the point-of-sale terminal to reduce, based on the second benefit, a purchase price associated with the purchase transaction.

In certain embodiments, the present disclosure relates to a system including a processor, and a memory device that stores a plurality of instructions. When executed by the processor, the instructions cause the processor to receive, from a mobile device executing a mobile device application, sporting event wagering data and location data. When executed by the processor responsive to the location data corresponding to a first retail establishment that is independent of any gaming establishment, the sporting event wagering data corresponding to a first amount of sporting event wagering activity, and a receipt of data associated with a purchase transaction initiated at a point-of-sale terminal associated with the first retail establishment, the instructions cause the processor to notify the point-of-sale terminal to complete the purchase transaction without any additional forms of payment. When executed by the processor responsive to the location data corresponding to the first retail establishment, the sporting event wagering data corresponding to a second, different amount of sporting event wagering activity, and the receipt of data associated with the purchase transaction initiated at the point-of-sale terminal associated with the first retail establishment, the instructions cause the processor to notify the point-of-sale terminal to reduce a total purchase price associated with the purchase transaction.

In certain embodiments, the present disclosure relates to a method of operating a system. Responsive to a receipt of data for a purchase transaction initiated at a point-of-sale terminal associated with a retail establishment that is independent of any gaming establishment, and a determination to authorize the purchase transaction based on an application of a first benefit earned from a first amount of sporting event wagering activity that occurred at the retail establishment, the method includes designating, by a processor, the first benefit as at least partially redeemed, and notifying the point-of-sale terminal to complete the purchase transaction without any additional forms of payment. Responsive to the receipt of data for the purchase transaction initiated at the point-of-sale terminal associated with the retail establishment and a determination to authorize part of the purchase transaction based on an application of a second benefit earned from a second amount of sporting event wagering activity that occurred at the retail establishment, the method includes designating, by the processor, the second benefit as redeemed, and notifying the point-of-sale terminal to reduce, based on the second benefit, a purchase price associated with the purchase transaction.

Additional features are described herein, and will be apparent from the following Detailed Description and the figures.

### BRIEF DESCRIPTION OF THE SEVERAL VIEWS OF THE DRAWINGS

FIG. 1 is an example configuration of the architecture of a plurality of different components of the system of the present disclosure.

FIGS. 2A and 2B are example graphical user interfaces displayed on a mobile device in connection with the earning and redemption of a benefit based on sporting event wagering activity occurring remote from a casino location.

### DETAILED DESCRIPTION

In various embodiments, the systems and methods of the present disclosure enable retail benefits for sporting event wagering activity occurring at a retail establishment independent of any casino location.

In certain embodiments, the system of the present disclosure offers one or more benefits in association with the remote placement of a sporting event wager. In these embodiments, in association with a placement of one or more sporting event wagers occurring at an establishment that otherwise does not offer benefits, the sporting event wagering system invokes the use of one or more benefits, such as comps, in association with the one or more placed sporting event wagers. For example, in association with a player placing one or more sporting event wagers at a location separate and distinct from any gaming establishment, such as a sports bar, the system determines a benefit, such as a free drink, and operates with the point-of-sale system of the location to deliver the determined benefit. As such, rather than offering a gaming establishment benefit (while remote from the gaming establishment) for placing a sporting event wager on a mobile device executing a mobile device application associated with a gaming establishment platform (which may require the player to travel to the gaming establishment to collect the benefit), the system offers readily available benefits for placing one or more sporting event wagers independent of any benefit accrued via the gaming establishment platform. Such a configuration thus enables access to certain benefits (e.g., comps and/or discounts) otherwise not available in association with the placed sporting event at the location of the placed sporting event. Accordingly, to extend the reach of a loyalty program for sporting event wagering activities undertaken at a specific location, the system operates to offer benefits to users, such as comps and/or discounts for goods and/or services purchased at the location, based on such sporting event wagering activities.

In operation of certain embodiments, following a component of a sporting event wagering system facilitating the placement of one or more sporting event wagers at an affiliated property, such as a retailer remote from a gaming establishment, the component of the sporting event wagering system determines whether to provide a benefit, such as a comp, in association with the sporting event wagering activity. In these embodiments, if the component of the sporting event wagering system determines to provide a benefit, the component of the sporting event wagering system interacts with a component of the affiliated property, such as a server of a retailer, to possibly determine a location of the user that placed the sporting event wagers and further provide, in real time, the determined benefit in association with the sporting event wagering activity. For example, following a player at a sports bar (i.e., a retailer separate from a gaming establishment) placing one or more sporting event wagers using a mobile device application being run on a mobile device and following a component of the sporting event wagering system determining to provide a benefit taking the form of a free appetizer to the player at the sports bar, the component of the sporting event wagering system operates with a component of the sports bar, such as a server of a sports bar food and drink system, to place the order for the free appetizer, arrange for payment for the appetizer from an account maintained by the component of the sporting event wagering system, determine a location of the player at the sports bar and provide the appetizer to the player at the determined location. As such, the system of the present disclosure enables certain benefits, such as couponing or discounting, to be offered in association with activities tracked by a sporting event wagering system that occur at a location not otherwise associated with offering such benefits.

It should thus be appreciated that unlike prior solutions in which a user could only receive benefits for sporting event wagering activities if the sporting event wagering activity occurred on a platform for tracking activities at a casino, the present disclosure enables a user to undertake sporting event wagering activities on such a platform while remote from the casino and still availing themselves access to benefits. In these embodiments, by offering benefits to individuals making sporting event wagers at partner establishments, the sporting event wagering system of the present disclosure promotes the placement of sporting event wagers while remote from a casino and further promotes user engagement at such partner establishments. That is, rather than requiring a user to travel to a casino to place one or more sporting event wagers on one or more sporting events and/or collect benefits earned for placing such sporting event wagers at the casino, the system of the present disclosure enables the user to place sporting event wagers from a partner establishment, such as a restaurant or bar, earn benefits for placing such sporting event wagers and collect the earned benefits, all without having to travel to a casino location. Such a configuration aids or otherwise provides an engaging experience for users by converting a passive experience (i.e., watching a sporting event from a non-casino location) into an active activity (i.e., placing a wager on one or more sporting event wagering opportunities associated with a sporting event and earning on-site benefits for doing so).

While the system of the present disclosure is generally described as using any suitable personal gaming device, such as a mobile device executing an application through which sporting event wagers are placed, from a location separate from a casino, the system may also employ any suitable electronic gaming machine (“EGM”) (such as, but not limited to, a sporting event wagering terminal, a slot machine, a video poker machine, a video lottery terminal, a terminal associated with an electronic table game, a video keno machine, and/or a video bingo machine that each may or may not also provide one or more wagering games to play) to place sporting event wagers from a location separate from a casino, any suitable component of a patron management system, such as a slot machine interface board (“SMIB”), which is in communication with an EGM and operable to enable the placement of sporting event wagers from a location separate from a casino, and/or any suitable combination of a sporting event wagering server operating with such a personal gaming device, with such an EGM, and/or with such a SMIB associated with such an EGM to offer one or more sporting event wagers. Additionally, while the system of the present disclosure is generally described as placing sporting event wagers from a retail location separate from a casino, such as a sports bar, in certain embodiments, the property which sporting event wagers are placed at (and which the sporting event wagering system causes benefits to be received in association with such sporting event wagers) may be any suitable location, including, but not limited to, a restaurant, a casino, a convenience store, a coffee shop or other similar businesses where people might sit and use a mobile device executing an application through which sporting event wagers are placed. Moreover, the location which sporting event wagers are placed at (and which the sporting event wagering system causes benefits to be received in association with such sporting event wagers) may be a single location or a plurality of related locations (e.g., if the owner of a particular bar owns or operates five other bars in the region, each of the bars may qualify as a location to earn and redeem benefits for sporting event wagering activities or a combination of two or more of such bars may qualify as a location to earn and redeem benefits for sporting event wagering activities).

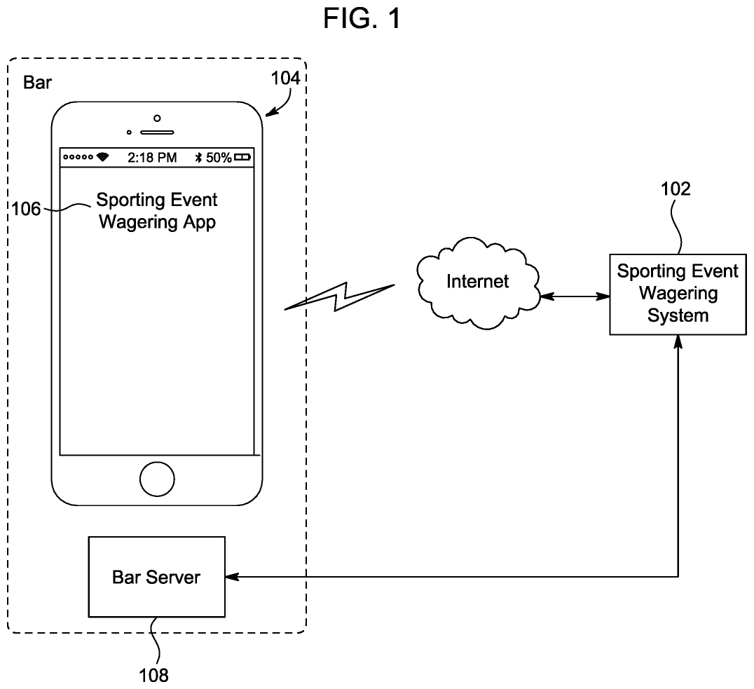

In various embodiments, the present disclosure is directed to one or more systems that operate individually or collectively to enable the placement of sporting event wagering independent of being located on casino premises, to determine zero, one or more benefits at least partially based on such sporting event wagering, and to enable the realization of zero, or more of such benefits independent of being located on casino premises. For example, as seen in FIG. 1, the system includes a sporting event wagering system 102 operable to offer sporting event wagering opportunities via a mobile device 104 running a mobile device application (e.g., sporting event wagering app 106) that interfaces with one or more components of the sporting event wagering system over the internet, such as using a virtual private network. As also seen in FIG. 1, the system includes one or more components of an affiliated property (e.g., bar server 108) that interfaces with one or more components of the sporting event wagering system to determine benefits in association with the sporting event wagering activity facilitated by the sporting event wagering system and/or redeem benefits determined in association with the sporting event wagering activity facilitated by the sporting event wagering system.

In various embodiments, upon a player accessing a mobile device application that enables the placement of one or more sporting event wagers, the sporting event wagering system creates a player account (or otherwise accesses a previously created player account). Such a player account is used to fund one or more wagers placed on one or more sporting event wagering opportunities associated with one or more sporting events accessible to the player remote from a gaming establishment location, such as accessible to the player from a restaurant or bar.

In certain embodiments in which the sporting event wagering system creates the player account when a player accesses the mobile device application, the sporting event wagering system creates the player account utilizing information provided by the player, such as, but not limited to, a government issued identification card, a government issued driver's license, a government issued passport, a government issued social security number, a portion of a government issued social security number (e.g., the last four digits), a gaming establishment player card, credit card information, debit card information, bank account information, biometric data (e.g., finger print, signature, or photo), or other such information. In certain embodiments, the sporting event wagering system accesses a previously created player account when the player accesses the mobile device application.

In certain embodiments, during creation of the player account (and/or access to a previously created player account), the sporting event wagering system requires the player to acknowledge a set of rules associated with the player account by providing a signature or other such indication that the player has read and agrees to the set of rules associated with the player account. For example, the set of rules of the player account includes: sporting event wagering limits of the player account, authorized users of the player account, acceptable funding sources of the player account, and other such rules.

In certain embodiments, the sporting event wagering system automatically creates the player account (or accesses a previously created player account) based on player information provided by a player to the affiliated property in association with a loyalty account maintained for that affiliated property. For example, if a sports bar includes a player loyalty system that tracks player's slot play and video poker play at the sports bar, the sporting event wagering system learns the player loyalty account information from the player loyalty system of the sports bar. In this embodiment, the sporting event wagering system utilizes information provided by the player such as, but not limited to, the age of the player, the home address of the player, previous preferences of the player, previous wagering history of the player, or other such information to automatically create the player account (or access a previously created player account) and enable the player to place sporting event wagers on one or more sporting event wagering opportunities from the retailer. In another embodiment, the sporting event wagering system enables an enrollment process for the player to associate two accounts, such as during the signup process to create a sporting event wagering account. In this embodiment, the player enters their credentials for an existing account, such as a player loyalty account of a player loyalty system of the retailer (and/or scans a machine-readable image, such as a QR code) to associate the two accounts. In these different embodiments, the automatic creation of the player account reduces time spent by the player because the player does not need to provide certain additional information (e.g., player age, or authorization to create player account) for the system to create the player account and enable the player to place a wager on one or more sporting event wagering opportunities from the retailer.

In certain embodiments, the system creates the player account based on information input by the player at a kiosk or other such registration device for the player account. In this embodiment, the player can utilize the kiosk to authorize the creation of a player account/access to a previously created player account to enable wagering on sporting event wagering opportunities at the retailer. Alternatively, the player can utilize the kiosk or mobile application prior to arriving at the retailer to authorize the creation of a player account/access to a previously created player account to enable wagering on sporting event wagering opportunities.

In certain embodiments, the system links or otherwise associates the player account with a specific location such that the system can track the wagering activity of the player account associated with the player's location. In one such embodiment, to associate a player account (and thus a player) with a specific location, the system prompts the player to use the mobile device application to key in identifying information of the specific location. In another embodiment, to associate a player account (and thus a player) with a specific location, the system prompts the player to use the mobile device application to scan a machine-readable image, such as a QR code, for the location. In this embodiment, the QR code has information for the mobile device application that uniquely identifies the location. In another embodiment, to associate a player account (and thus a player) with a specific location, the system employs geolocation by causing the mobile device application to query the system with its geolocation to learn the identity of the location. In another embodiment, to associate a player account (and thus a player) with a specific location, the mobile device application joins the WIFI of the retailer. In one such embodiment, the system determines that the player is joining from a certain public IP address and associate the IP address with a particular location. In another such embodiment, the mobile device application learns from the local retailer network the identity of the location, such as by identifying a certain dhcp entry or identifying some service on the local network. In another embodiment, to associate a player account (and thus a player) with a specific location, the system employs iBeacons (or other Bluetooth devices) at the retailer that broadcast information to the mobile device application about the identity of the location.

In certain embodiments, once the sporting event wagering system generates or otherwise accesses the player account, the sporting event wagering system enables the player to fund the player account. In certain embodiments wherein the system automatically creates or accesses the player account, the player account is associated with a gaming establishment wagering account fundable by the player (and utilized by the player to place wagers on sporting event wagering opportunities while at a gaming establishment). In certain embodiments, the system enables the player to fund the player account using credit card information, debit card information, bank account information, currency, or other such funding source. In another embodiment, prior to placing any sporting event wagers at a retailer, the system requires the player to visit a sports book of a gaming establishment to fund the player account using credit card information, bank account information, currency, or other such funding source provided by the player. As described below, the player utilizes funds in the player account for placing wagers on sporting event wagering opportunities. Additionally, in certain embodiments, the system enables the player to utilize the funds in the player account for non-sporting event wagering activities at the retailer, such as, but not limited to, purchasing goods (e.g., purchasing food and beverages) at the retailer, purchasing services at the retailer and/or undertaking wagering activities at the retailer other than sporting event wagering activities.

In certain embodiments, when funding the player account, the sporting event wagering system enables a set of regulations on the funds added to the player account for placing wagers on sporting event wagering opportunities. In this embodiment, the regulations on the player account are configured such that the system monitors the wagering activity of the player while utilizing the player account. For example, certain regulations associated with wagering on sporting event wagering opportunities include placing a maximum wagering amount that a player can wager in a 24-hour period, a wagering session, or other such wagering timeframe. In this embodiment, the system uses player information collected during creation of the player account such as, a government issued identification card, a government issued driver's license, a government issued passport, a government issued social security number, a portion of a government issued social security number (e.g., the last four digits), a gaming establishment player card, credit card information, debit card information, bank account information, biometric data (e.g., finger print, signature, retinal scan or facial feature scan or photograph), or other such information to set up monitoring of the player account. In certain such embodiments, as indicated above, the player provides such information to verify their identity. In certain other such embodiments, the system collects such information from the player to create and monitor an anonymous identification associated with a player (wherein such collected information is utilized to verify the anonymous player). As such, the sporting event wagering system monitors any wagers placed by a player using the player account against the maximum wager amount that the player can wager during the 24-hour period. In certain embodiments, if the player exceeds this maximum wager amount, the system may notify the player that wagering limits have been reached and the system disables the player from placing additional wagers utilizing the player account for the remainder of the 24-hour period.

In certain embodiments, any wagers placed on sporting event wagering opportunities utilizing the player account are charged against a running invoice or tab maintained at the retailer. That is, when a player places a wager utilizing the player account, the sporting event wagering system charges the player's running invoice for the placed wager. As such, upon settling the running invoice at the retailer (e.g., paying for any food and drinks ordered at a sports bar), the player pays any remaining outstanding balance of the player account for any wagers placed on sporting event wagering opportunities, and the player receives any remaining payouts received by the player account from wagers placed on sporting event wagering opportunities. It should be appreciated that in certain embodiments wherein the player account is included in the running invoice, the sporting event wagering system places a limit on the amount that the player can wager on sporting events such that any wagers placed on sporting events and added to the player's tab do not account for a majority of the charges. Such an embodiment of utilizing a running invoice at a retailer for wagering opportunities provides the benefit of the retailer being able to use a merchant category code (MCC) consistent with charging for non-gambling activity (i.e., fees for food and drinks) rather than using an MCC consistent with gambling activities because the majority of credit card issuing banks generally approve charges associated with non-gambling activity but may deny charges associated with gambling activities.

In addition to funding a player account, the sporting event wagering system enables the player to access sporting event wagering opportunities via the mobile device application. Such sporting event wagering opportunities enable the placement of any suitable type of wager on any event, such as any suitable sporting event, accessible from a device associated with a user that qualifies to place such a wager. In these embodiments, the sporting events available to be wagered on include any suitable event of any suitable sport at any professional and/or amateur level including, but not limited to, football, basketball, baseball, boxing, horse racing, wrestling, mixed martial arts, golf, cricket, soccer, hockey, field hockey, tennis, volleyball, table tennis, rugby, swimming, diving, archery, cycling, billiards, fishing, gymnastics, hunting, track and field, sailing, and/or car racing. In these embodiment, the non-sporting event available to be wagered on include any suitable non-sport with an initially outcome unknown which an odds maker presents odds for, such as wagering on political events or wagering on televised wagering events (e.g., wagering on televised poker tournament events). It should be further appreciated that one or more of the available sporting event wagering opportunities and the associated sporting events may be selected by a player, selected by an operator, such as a sports bar operator, or selected based on scheduling (i.e., which sporting events are currently being played live), popularity (e.g., sporting events including sports teams from more populous cities are selected over sporting events including sports teams from less populous cities) and/or location (e.g., a sporting event played at a first location relatively closer to a sports bar is selected over a sporting event played at a second location relatively further away from the sports bar).

In certain embodiments, one or more of the available sporting event wagering opportunities displayed include sporting event wagering opportunities associated with a live or upcoming sporting event wherein the sporting event wagering system operates with one or more servers of a retailer to display information (e.g., live sports book information obtained via a sports betting service) regarding the live or upcoming sporting event. In certain embodiments, one or more of the available sporting event wagering opportunities displayed include sporting event wagering opportunities associated with historical sporting events, such as a prerecorded sporting event, or a recreation of a prior sporting event. In these embodiments, to prevent players from determining an outcome of the historic sporting event prior to placing any wagers on one or more sporting event wagering opportunities associated with that historic sporting event, the system masks certain of the identifying information associated with that sporting event. That is, the sporting event wagering system anonymizes identifying information about teams, historical team records, sporting event players, and/or historical sporting event player statistics each time that information is presented to players to select whether to wager on a given sporting event wagering opportunity. In certain embodiments, one or more of the available sporting event wagering opportunities are associated with virtual or electronic sport (“eSport”) events. In these embodiments, such virtual or eSports events are played by humans, by computer driven participants or by a mix of human and computer driven participants.

In certain embodiments, the sporting event wagering system displays, via the mobile device application, pertinent wagering information regarding the one or more sporting event wagering opportunities available to be placed, such as, but not limited to, the participants in the sporting event (including historic information regarding such participants in the sporting event), the odds of a particular action or event occurring in the sporting event, the amounts available to be wagered, and/or the awards provided if the different sporting event wagering opportunities are determined to be winning wagers placed on sporting event wagering opportunities. It should be appreciated that the sporting event wagering opportunities displayed to the player includes any suitable sporting event wagering opportunity including, but not limited to, any suitable moneyline wager on an outcome of a sporting event (e.g., Team X will win the game), any suitable wager on an outcome of a sporting event which accounts for a point spread (e.g., Team X will win the game by ten points), any suitable proposition wager on an in-game event occurring or not occurring within the sporting event (e.g., Player A will score the next touchdown), any suitable handicap wager, any suitable if and reverse wager, any suitable total/over-under wager, any suitable full cover wager, any suitable future/outright wager, any suitable parlay/accumulator multiple sporting event wagers (including but not limited to a progressive parlay wager, a teaser and pleaser wager, a grand salami wager, and/or a round robin wager) and/or any combination of these different available sporting event wagering opportunities.

In certain embodiments, the available sporting event wagering opportunities are associated with a wager amount and a parimutuel award which is determined after all sporting event wagers have been placed on the available sporting event wagering opportunities. In these embodiments, the selection of a sporting event wagering opportunity includes the selection of an amount to wager on the sporting event wagering opportunity wherein all sporting event wagering opportunities of a particular type are placed together in a pool and then after the deduction of applicable fees (e.g., the vigorish) and/or taxes, the payoff odds are determined by sharing the pool among all winning bets.

In certain embodiments, the system enables the player to reject one or more of the sporting event wagering opportunities available to be placed and select another one or more different sporting event wagering opportunities to potentially wager on. That is, similar to a sports book wherein a player is presented with many sporting event wagering opportunities that they can place different wagers upon, the system enables a player to reject one or more of the sporting event wagering opportunities presented to the player such that another subset of one or more sporting event wagering opportunities are subsequently presented to be potentially placed. In another embodiment, multiple sporting event wagering opportunities within the sporting event are presented to the player via the mobile device application, and the system enables the player pick a subset of the sporting event wagering opportunities presented to place. In this embodiment, if the player picks more than one sporting event wagering opportunity to place within one or more sporting events, the system employs a parlay bet with adjusted odds. In another embodiment, the system requires the player to place a primary wager on a sporting event wagering opportunity wherein two or more subsequent sporting event wagering opportunities placed within one or more sporting events are associated with a parlay bet with adjusted odds.

In certain embodiments, once the system displays the available sporting event wagering opportunities, the system enables the player to use funds from the player account to place one or more wagers on one or more of the displayed sporting event wagering opportunities. In this embodiment, the player uses an input device, such as the mobile device executing the mobile device application, to input a selection of one or more sporting event wagering opportunities and input a wager amount associated with the selected one or more sporting event wagering opportunities. If adequate funds are available and no limitations are breached, such inputs result in the sporting event wagering system (operating individually or with a system that maintains the funding of the player account) deducting the wager amount from the balance of the player account to cause the selected sporting event wager to be placed. In certain embodiments, the system enables the player to freely input and confirm one or more wagers placed on the displayed sporting event wagering opportunities. In another embodiment, the system requires the player to first input a personal identification number (“PIN”), a password, or other such player identifier prior to enabling the player to input and confirm one or more wagers placed on the displayed sporting event wagering opportunities.

In certain embodiments, upon the placement of sporting event wagers, the system creates a betting slip (in paper or electronic form) associated with placed wager. In one such embodiment, the betting slips are provided to the player upon creation, such as being emailed to the player (if in electronic form) or printed by a printer (located in the retailer).

In certain embodiments, in addition to enabling sporting event wagers to be placed on sporting event wagering opportunities from a location where benefits for such placed sporting event wagers are not otherwise earned or redeemed, the sporting event wagering system determines if the player won any sporting event wagers placed on any sporting event wagering opportunities. In certain embodiments, if the system determines that the player won at least one wager that was placed on at least one sporting event wagering opportunity, then the system funds the player account with a payout associated with that winning wagered on sporting event wagering opportunity. On the other hand, if the system determines that the player did not win any of the wagered on sporting event wagering opportunities, then no funding of the player account occurs and the system continues to display one or more available sporting event wagering opportunities associated with one or more sporting events.

In addition to monitoring for any wins resulting from sporting event wagers placed from a location where benefits for such placed sporting event wagers are not otherwise earned or redeemed, in certain embodiments, the sporting event wagering system operates with a server of the retailer, such as an entertainment server of a sports bar, to display, on one or more community displays, such as televisions, one or more sporting events that at least one or more sporting event wagers were placed on. In these embodiments, the players at the retailer can control the community displays in that location in a direct or an in-direct manner. In one such embodiment, the sporting event wagering server operates with a server of the retailer to ensure that a community display at the retailer is displaying a sporting event which has at least one sports wager placed on it from patrons of that retailer. In certain embodiments, the sporting event wagering server operates with a server of the retailer to prioritize what sporting event to place on the various community displays at the retailer based upon how many wagers have been placed by patrons on a particular event. In certain embodiments, the sporting event wagering server operates with a server of the retailer to enables one or more players to choose to change the channel of a community display in exchange for earned player tracking points and/or comps. In another embodiment, the sporting event wagering server operates with a server of the retailer to enable players of a certain status (e.g., players at or above a certain player tracking rank) to directly control one or more community displays in the location. In another embodiment, the sporting event wagering server operates with a server of the retailer to enable players of a certain status to send a request to change a channel on one or more community displays and a staff member can change the channel accordingly.

In certain embodiments, the sporting event wagering server operates with a server of the retailer to overlay or otherwise display the available sporting event wagering opportunities on one or more community displays in the retailer. For example, for a football game between Team X and Team Y, the sporting event wagering server operates with an entertainment server of the retailer to display a plurality of football game wagering opportunities such as plurality of different pre-game wagers, in-game wagers and any other such wagers available to place on the football game. In these embodiments, the sporting event wagering system communicates with the server of the retailer that controls the community displays to send video data such that any available sporting event wagering opportunities are included in video signals transmitted by the community displays of the retailer. In one example, the system overlays the available sporting event wagering opportunities on top of the displayed sporting event. As a result, the patrons of the retailer can view the available sporting event wagering opportunities while simultaneously viewing the sporting event displayed on the televisions in the retailer. In another embodiment, the system scales down the display of the sporting event and the available sporting event wagering opportunities are displayed in an area besides the displayed sporting event, below the displayed sporting event, or above the displayed sporting event. In this embodiment, the system displays an unobstructed view of the sporting event while also displaying the available sporting event wagering opportunities associated with the sporting event. As a result, the patrons of the retailer can view the available sporting event wagering opportunities while simultaneously viewing the sporting event.

In certain embodiments, the sporting event wagering system operates with one or more components of the retailer, such as an entertainment server, to display one or more leaderboards regarding the sporting event wagering activities of the patrons of that retailer. In certain embodiments, to promote the sporting event wagering activity at the location, the leaderboard shows recent sporting event wagering activity, such as, but not limited to, recent wins, large wins, placed bets that are outstanding, bets for a particular game, wins for a particular game or sporting event, and/or comp activity. In another embodiment, the leaderboard shows information beyond what is applicable for the current site. For example, the bets for a particular game for all sports bars owned by a bar owner may be shown, or bets across all connected sites in a geographical area may be shown. In this example, the leaderboard additionally (or alternatively) shows relative ranking information, such as how bettors at the current site stack up against other sites.

In certain embodiments, in addition to showing sporting event wagering activity on a leaderboard, the system employs the leaderboard to provide secondary prizes at a particular location based on the sporting event wagers placed and/or wins for that location. For example, if the players at a particular sports bar win the most in comparison to other sports bar, all patrons at the winning sports bar win a free drink from the sporting event wagering system. In another example, if the players at a particular sports bar win the most in comparison to other sports bar, all patrons at the winning site who wagered for the associated sporting event (or series of events) win a free drink from the sporting event wagering system. Such promotions are in addition to (or alternative from) the benefits earned by players for undertaking sporting event wagering activity at the location location where benefits for such placed sporting event wagers are not otherwise earned or redeemed.

In certain embodiments, in addition to enabling the player to use funds from the player account to place wagers on the displayed sporting event wagering opportunities, a component of the sporting event wagering system operates with zero, one or more components of other systems, such as a component of the retailer system to determine, at least partially based on the player's sporting event wagering activities, zero, one or more benefits, such as comps, coupons and/or discounts, to associate with the player and/or the attributes of such benefits (e.g., the value of such benefits, any expiration of such benefits). In certain embodiment, the system determines to associate any benefits with the player and/or the attributes of any such benefits based on the player's sporting event wagering activity. In certain embodiments, the determination of whether or not to provide any benefits and/or the attributes of any such benefits is based on an amount of the sporting event wagers placed during a designated time period. In certain embodiments, the determination of whether or not to provide any benefits and/or the attributes of any such benefits is based a quantity of sporting event wagers placed during a designated time period. In these different embodiments, to incentivize a player to place sporting event wagers at a partner establishment, the sporting event wagering system, operating alone or in conjunction with one or more components of the retailer, determines one or more benefits to associate with the player. In these embodiments, to better foster the relationship between the sporting event wagering system and various establishments, such as sports bars where sporting event wagering activities often take place, and to build or grow player loyalty to the sporting event wagering system, the system utilizes benefits in association with sporting event wagering activities.

In another embodiment, the system additionally or alternatively determines to associate any benefits with the player and/or the attributes of any such benefits based on the player's purchasing activity. In certain embodiments, the determination of whether or not to provide any benefits and/or the attributes of any such benefits is based on an amount of non-sporting event wagering spend at the location during a designated time period. In certain embodiments, the determination of whether or not to provide any benefits and/or the attributes of any such benefits is based a quantity of non-sporting event wagering transactions at the location during a designated time period.

In certain embodiments, the determination to associate any benefits with the player and/or the attributes of any such benefits is based on one or more actions of a player. In another such embodiment, in exchange for signing up to participate in a sporting event wagering system program, the system additionally or alternatively determines to associate one or more benefits with that player. In another such embodiment, in exchange for signing up to participate in a player loyalty program for the affiliated property, the system determines to associate one or more benefits with that player.

In certain embodiments, the determination of whether or not to provide any benefits and/or the attributes of any such benefits is based one or more events that occurred (or did not occur) in the wagered on sporting events. In these examples, in addition to potentially winning one or more awards based on what occurs (or does not occur) during a wagered on sporting event, the system determines one or more benefits and/or the attributes of any such benefits based on the sporting event.

In certain embodiments, the determination to associate any benefits with the player and/or the attributes of any such benefits is additionally or alternatively based on an identity of the player. In one such embodiment, different players having different status with the affiliated property are offered different benefits. In another such embodiment, the system determines to associate any benefits with the player and/or the attributes of any such benefits based on determined historical preferences of the player.

In certain embodiments, the determination to associate any benefits with the player and/or the attributes of any such benefits is additionally or alternatively based on one or more parameters of the affiliated property. For example, as part of a marketing campaign associated with the affiliated property, the system associates one or more benefits with one or more players. In certain embodiments, a determination to associate any benefits with the player and/or a determination of the attributes of any such benefits occurs responsive to one or more inputs received from affiliated property personnel.

In certain embodiments, if the system determines to associate one or more benefits with the user, the system stores benefit information in one or more accounts associated with the user. In one such embodiment, the system maintains a benefit account that stores data associated with the different benefits associated with the user.

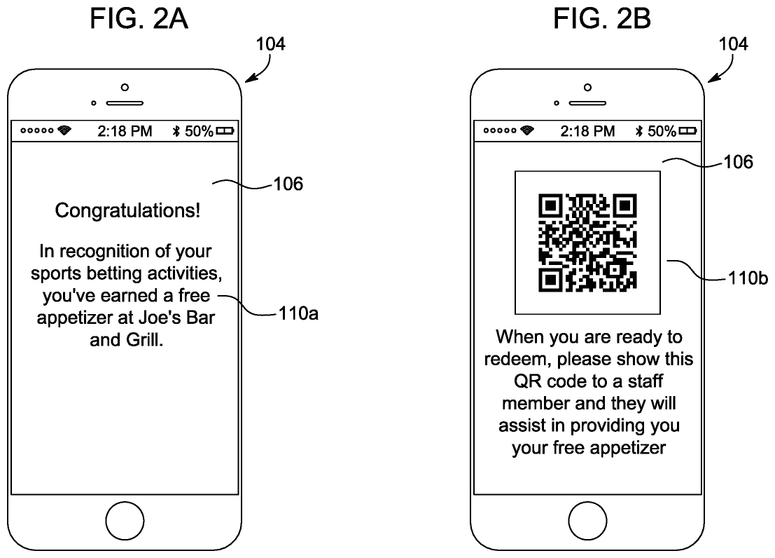

In certain embodiments, upon the determination of the benefit, the system communicates an indicator of the benefit to the player, such as notifies the player, via a message displayed at any suitable device, via an email, via an SMS or text message, and/or via a notification displayed by a mobile device application. In these embodiments, the associated benefits qualify as virtual benefits. For example, as seen in FIG. 2A, following a determination to provide a patron of Joe's Bar and Grill a free appetizer in recognition of the patron's sporting event wagering activities, the system communicates data to the mobile device 104 which results in the mobile device application 106 displaying a message to the patron 110a regarding the earned benefit. In certain additional or alternative embodiments, if the system determines to associate one or more benefits with the player, physical benefits, such as paper coupons, are issued to the player (wherein to redeem, the player provides the physical benefit to affiliated property personnel and/or affiliated property personnel scans a machine-readable code printed on the physical benefit).

In certain embodiments, a benefit is associated with a specific affiliated property. In certain embodiments, a benefit is associated with a plurality of affiliated properties. In certain embodiments, the plurality of affiliated properties are associated with each other (e.g., sister bars at different locations or different restaurants located in the same mall) or independent of each other (e.g., distinct bars located remote from each other). In certain embodiments, a benefit is associated with one or more participating affiliated properties within a geographic location.

In certain embodiments, a benefit is associated with one or more qualifying criteria. In these embodiments, prior to a benefit being redeemed, any qualifying criteria associated with that benefit need to be satisfied. In certain such embodiments, the qualifying criteria pertain to when that benefit may be redeemed. In certain such embodiments, the qualifying criteria additionally or alternatively pertain to the user completing one or more activities, such as the user having to make a minimum purchase amount for a benefit to become redeemable.

In certain embodiments, a benefit is associated with one or more limits or controls. In these embodiments, prior to a benefit being redeemed, the sporting event wagering system, the point-of-sale system and/or an retailer system determine whether any applicable limits or controls are in place that prevent the benefit from being redeemed. Such limits or controls offer protection to the party funding the benefit by ensuring that benefit use corresponds with the intention of the promotional program.

In certain embodiments, the system enables an operator to determine and activate zero, one or more benefit limits to associate with one or more benefits. In these embodiments, if any operator determined benefit limits are violated, the system attempts to prevent unauthorized use of such a benefit. In certain embodiments, the determination to associate one or more benefit limits is based on one or more inputs from an operator wherein personnel indicate that they would like one or more benefit limits associated with certain of (or each of) the benefits made available.

In certain embodiments, the system enables a point-of-sale system to determine and activate one or more benefit limits to associate with transactions undertaken by the point-of-sale system. In certain of these embodiments, the determination to associate one or more benefit limits is based on one or more inputs from personnel whom indicate that they would like one or more benefit limits associated with certain of (or each of) the benefits available to use in association with the point-of-sale system. In certain other of these embodiments, the determination to associate one or more benefit limits is based on one or more settings associated with the point-of-sale system that dictate one or more benefit limits associated with certain of (or each of) the benefits available to use in association with the point-of-sale system. In certain embodiments, one or more determinations are made at the point-of-sale terminal level wherein different terminals are associated with different benefit limits. In certain embodiments, one or more determinations are made at the point-of-sale system level wherein each terminal is associated with the same benefit limits.

In certain embodiments, the system enables a user, such as affiliated property personnel, to determine and activate zero, one or more benefit limits. In these embodiments, if any user determined benefit limits are violated, the system attempts to prevent unauthorized use of such a benefit. In certain embodiments, the determination to associate one or more benefit limits is based on one or more inputs from the user wherein the user indicates that they would like one or more benefit limits associated with certain of (or each of) the benefits available to use.

In certain embodiments, the benefit limits are associated with an identity of whom may place a sporting event wager. For example, the sporting event wagering system and/or the retailer system determines that a user enrolled in player tracking system who qualifies as a bronze status member may have access to a first tier of benefits, while another user who qualifies as a platinum status member may have access to a second tier of benefits. In certain embodiments, one or more activities of the identified user may factor into the employment (or lack thereof) or benefit limits.

In certain embodiments, the benefit limits are associated with a quantity and/or an amount of transactions that attempt to apply the benefit over a given period of time (e.g., hourly, daily, weekly, monthly). In these embodiments, to prevent a user from employing too many benefits, the sporting event wagering system, the point-of-sale system and/or the retailer system places a per time period limit on benefits used. For example, if a promotion requires a user to gamble $100 on sporting events and have dinner at the sports bar to earn a benefit at the sports bar, then the promotion may limit the user to earn only one benefit for a given period of time. In another example, certain benefits may be applied only one time (i.e., one time use benefits), while other benefits may be applied an unlimited number of times or up to a maximum number of times. In certain embodiments, the benefit limits are additionally or alternatively associated with the amount of a transaction that attempts to apply the benefit. In certain embodiments, the benefit limits are imposed if the benefit is for a percentage discount. For example, a benefit could be a 5% discount on dinner at any partner restaurant, but up to a $100 bill amount. In another example, a benefit that offers a percentage discount may not have any purchase limit. In certain embodiments, certain retail purchases having a value above a threshold value that trigger the use of one or more benefit limits while other retail purchases that have a value below the threshold value do not trigger such benefit limits.

In certain embodiments, the benefit limits are associated with an identity of the affiliated property at which the sporting event wagering activity is occurring at. In these embodiments, the sporting event wagering system, the point-of-sale system and/or the retailer system imposes, using a Merchant Category Code (MCC) or a whitelist or blacklist of retailers, benefit limits on a type of industry thus eliminating an entire class of merchants from participating in the program.

It should be appreciated that in certain embodiments, one or more of the benefit limits may be overridden and/or adjusted by qualifying personnel. In these embodiments, the sporting event wagering system, the point-of-sale system and/or the retailer system associates different levels of overriding and/or adjusting of benefit limits with different qualifying personnel. In these embodiments, the sporting event wagering system, the point-of-sale system and/or the retailer system enables different levels of overriding and/or adjusting of benefit limits for different users based on one or more attributes, such as status or historical sporting event wagering activities, of such users.

In certain embodiments, if the sporting event wagering system determines to provide a benefit to a player in association with sporting event wagering activities undertaken by the player, the system may need to locate the player to provide the determined benefit. That is, while the benefit and the player to whom shall receive the benefit are known, the location of the player within the affiliated property may be unknown and needs to be determined.

In certain embodiment in which the the benefit is presented in virtual or electronic form using a mobile device application, the mobile device application prompts the player to cause the mobile device to engage a point-of-sale terminal or kiosk, such as prompting the user to tap the mobile device to a designated portion of the point-of-sale terminal or kiosk (or otherwise moving the mobile device to within a designated distance of a designated location of the point-of-sale terminal or kiosk). Such engagement initiates a pairing or linkage between the mobile device and the point-of-sale terminal or kiosk, wherein the pairing or linkage between the mobile device and the point-of-sale terminal or kiosk occurs via one or more applications being run or executed on the mobile device. In this example, after such engagement, the mobile device application communicates, via a wireless communication protocol (including, but not limited to: Bluetooth™, Bluetooth™ Low Energy (“BLE”), one or more cellular communication standards (e.g., 3G, 4G, 5G, 6G, LTE), one or more Wi-Fi compatible standards, and one or more short range communication protocols (e.g., a near field communication (“NFC”) protocol), data associated with the benefit to the point-of-sale terminal or kiosk to locate the player and facilitate the redemption of the benefit for the purchase of goods and/or services. In another example, a unique NFC sticker is placed at every table location at a sports bar and/or on every seat location at the sports bar counter. In this example, the mobile device engaging the NFC sticker causes the mobile device application to determine the seat location, and/or an identifier that can be used to determine the seat location of the player and communicate that data to one or more components tasked with providing the benefit.

In another embodiment, the benefit is issued with a QR code and a unique value to the player's mobile device. In this embodiment, when it is time to redeem the benefit, personnel at the retailer scans the QR code displayed on the player's mobile device to confirm it is the correct player and/or to verify the comp was issued to the correct player. For example, as seen in FIG. 2B, when the patron of Joe's Bar and Grill is ready to redeem the free appetizer provided in recognition of the patron's sporting event wagering activities, the patron utilizes their mobile device 104 executing the mobile device application 106 to display the QR code 110 needed to obtain the earned benefit. In another embodiment, the benefit is issued in association with the player's name to assist personnel in locating the player. In another embodiment, to locate the player, the mobile device application enables the player to input location identifying information, such as “table 42” or “by the pool tables”, that assist personnel in locating the player.

In certain embodiments in which sporting event wagers are placed at an EGM, since each EGM has a unique identifier and the operator of the location knows the location of each EGM by that identifier, the sporting event wagering system can monitor the sporting event wagering activity happening at the EGM to locate the player to provide a comp to the player at that EGM. In certain other embodiments in which sporting event wagers are placed at an EGM, if the player's mobile device is otherwise in communication with the EGM, the sporting event wagering system utilizes this wireless connection to locate the player to provide a comp to the player at that EGM. For example, if a player is otherwise using a mobile device to login into a player loyalty account to earn loyalty points for video poker play occurring at an EGM, since the mobile device application is now associated with that EGM, when the player places sporting event wagers using the mobile device, the mobile device reports that the player is playing at the EGM by reporting the unique identifier of the EGM to the sporting event wagering system.

In certain embodiments, following any determination of the location of the player to provide the benefit to, the sporting event wagering system operates with one or more systems of the affiliated property to directly offer benefits, such as comps, coupons and/or discounts, in association with the sporting event wagering activities undertaken by the located player and independent of any goods and/or services purchase activities of the player. For example, the sporting event wagering system issues a command to a component of the sports bar, such as a server, to give a player a free drink based on the sporting event wagering activity of that player. In this example, a player's name is displayed on a screen at a sports bar and upon seeing their name and that they have earned a comp, such as a free drink, for their sporting event wagering activities, the player notifies an employee of the sports bar who then scans a QR code displayed on the player's mobile device and issues the comp item. In another example, following the sporting event wagering system issuing a command to a component of the sports bar, such as a sports bar food and beverage server, to give a player at an identified seat location a free drink based on the sporting event wagering activity of that player, the sports bar food and beverage server instructs sports bar personnel give the player the drink and the mobile device application of the player's mobile device in turn displays a notification, such as a thank you message, to inform the player that they received the drink for using the mobile device application to place sporting event wagers via the sporting event wagering system.

In certain embodiments, the benefit earned and provided is a specific, identified benefit, such as a specific drink. In these embodiments, the benefit earned may be based on player preferences and/or past benefits. In certain embodiments, the benefit earned and provided is a non-specific benefit, such as “a $5.00 drink” or a “Tier A” drink (based on the sporting event wagering system and the sports bar operator having agreed on a tiering system). In these embodiments, the system offers the player one or more benefits that correspond to the non-specific benefit earned (that, may be based on player preferences and/or past benefits) and the player (or other personnel) selects the benefit provided.

It should be appreciated that these examples, the operator of the sporting event wagering system and the sports bar have a business relationship such that the two partners split the cost of the comps provided to sports bar patrons for placing sporting event wagers. In another example, despite any business relationship, the sporting event wagering system (or alternatively the sports bar) pays for the entire comp. In this example, one or more accounts are maintained in association with the sporting event wagering system (or alternatively the sports bar) that funds are drawn from to pay for the benefits provided in association with placing sporting event wagers. In another embodiment, the sporting event wagering system funds the comp players earn for placing sporting event wagers by splitting, with an operator of a location, a percentage of the gross gaming revenue associated with that location, based on a ratio configured to fund all player loyalty comps plus any additional return due to the location operator.

In certain embodiments, the sporting event wagering system is integrated with a system of the affiliated property to offer benefits, such as comps, coupons and/or discounts, in association with sporting event wagering activities undertaken as part of a purchase transaction at the affiliated property. In certain embodiments, the system of the affiliated property includes or is otherwise integrated with a point-of-sale system such that the sporting event wagering system informs the point-of-sale system to remove (or reduce) the cost of an item on the player's bill as a comp for the player's sporting event wagering activities. For example, the player ordered a beer and the sporting event wagering system informs the point-of-sale system to remove the cost of the beer and the sporting event wagering system further communicates data to the player's mobile device that causes the mobile device application to inform the player of the comp with messaging such as “Thanks for playing, your drink is on us!”

More specifically, in certain embodiments, to employ an associated benefit to fully or partially purchase goods and/or services from the affiliated property, the components of the systems individually or collectively determine whether or not to apply any associated benefits. In certain such embodiments, the system automatically applies any applicable benefits associated with the user (e.g., any valid and unexpired benefits applicable at least because the user has satisfied any qualifying criteria and the benefit is not in violation of any benefit limits). In certain other embodiments, the system applies any applicable benefits associated with the user (e.g., any valid and unexpired benefits applicable at least because the user has satisfied any qualifying criteria and the benefit is not in violation of any benefit limits) responsive to one or more inputs received from the user to apply any benefits, such as the user selecting the benefits to use and/or approving the benefits to be used. In these embodiments, if one or more benefits are designated to be applied, the sourcing of the purchase amount of the goods and/or services may be split between a presented form of payment and funds attributed to the benefit (which may, in certain instances, take the form of a discount to the amount needed to purchase the goods and/or services).

In certain embodiments, a point-of-sale system communicates with the sporting event wagering system and/or the retailer system to determine the applicability of any benefits. In these embodiments, if an applicable benefit is applied to offset the entire purchase price, the goods and/or services are provided as the benefit without any additional form of payment required. On the other hand, if an applicable benefit is applied to offset part of the purchase price, a reduced amount of a presented form of payment is required to complete the purchase of the goods and/or services. Following the application of the benefit in association with the purchase of goods and/or services from the affiliated property, the system updates one or more databases to reflect the usage of the benefit. In different embodiments, depending on whether the benefit is a one-time use benefit or a multiple use benefit, the designation of the benefit as being used determines a use state of the benefit in the database.

In certain embodiments, rather than directly providing a benefit to a player for their sporting event wagering activities, the sporting event wagering system rewards players for their sporting event wagering activities with a quantity of points that are redeemable for goods and/or services at the affiliated property. In these embodiments, players could consume reported balances, such as a point balance, or unreported balances, such as comp balance, when the player requests goods and/or services at the affiliated property. For example, a player could request a drink at a sports bar, and a staff member at the sports bar could pay for the drink using the player's current point balance, or comp balance. In this example, if the player does not have enough funds in either a reported, or unreported balance, then the player may have to pay for all or a portion of the drink using another form of payment. In certain embodiments, the system enables a user to convert, at a conversion rate, an amount of points to an amount of a discount applied to fund a purchase. In different embodiments, the conversion rate is static across all partner affiliated properties or varies based on the partner affiliated property, the identity of the user and/or one or more activities undertaken by the user. In different embodiments, the retailer system automatically converts (or converts responsive to a request from the user) the maximum amount of points possible to fund a discount for the user's purchase. Put differently, in different embodiments, the system automatically applies any applicable discounts or applies any applicable discounts responsive to one or more inputs received from the user to apply such discounts, such as the user selecting an amount of points to convert for a discount to use and/or approving a determined discount available in exchange for points.

In certain embodiments in which the benefit takes the form of a quantity of points, the points for sporting event wagering activities are maintained in an account associated with the retailer independent of any other loyalty program points (e.g., bar loyalty points, non-sporting event wagering points) otherwise associated with the retailer. In certain other embodiments in which the benefit takes the form of a quantity of points, the points for sporting event wagering activities are maintained in an account associated with the retailer along with any other loyalty program points (e.g., bar loyalty points, non-sporting event wagering points) associated with the retailer. For example, if a sports bar includes EGMs that the player may earn loyalty points for wagering at, both the player's wagering activity at the EGM at the sports bar and the player's sporting event wagering activity at the sports bar earn the player loyalty points.

While certain embodiments of the present disclosure employ benefits for sporting event wagering activities taking the form of comps, coupons and discounts, other embodiments employ benefits for sporting event wagering activities taking the form of access to special events and/or locations. In certain such embodiments, the sporting event wagering system associates players with ranks or tiers based upon their sporting event wagering activity and the players sporting event wagering activity and/or rank entitle them to access to special private events at the retailer, which further cements value in the player's loyalty to the retailer. In certain embodiments, the retailer leverages the sporting event wagering system to create a special event (e.g., an exclusive Super Bowl party) and invite players who match certain pre-defined criteria and grant them access to that event. In these embodiments, the sporting event wagering system notifies players of their exclusive invitation to the event, such as by emailing the qualified players, sending them an SMS/Text message, and/or sending them a push notification. In different embodiments, such an event is related or tied to a sporting event or such an event is a player appreciation event unrelated to any sporting event.

Accordingly, the system of the present disclosure offers one or more benefits in association with the remote placement of a sporting event wager. In these embodiments, in association with a placement of one or more sporting event wagers occurring at an establishment that otherwise does not offer benefits, the sporting event wagering system invokes the use of one or more benefits, such as comps, in association with the one or more placed sporting event wagers. For example, in association with a player placing one or more sporting event wagers at a location separate and distinct from any gaming establishment, such as a sports bar, the system determines a benefit, such as a free drink, and operates with the point-of-sale system of the location to deliver the determined benefit. As such, rather than offering a gaming establishment benefit (while remote from the gaming establishment) for placing a sporting event wager on a mobile device executing a mobile device application associated with a gaming establishment platform (which may require the player to travel to the gaming establishment to collect the benefit), the system offers readily available benefits for placing one or more sporting event wagers independent of any benefit accrued via the gaming establishment platform. Such a configuration thus enables access to certain benefits (e.g., comps and/or discounts) otherwise not available in association with the placed sporting event at the location of the placed sporting event. That is, unlike prior solutions in which a user could only receive benefits for sporting event wagering activities if the sporting event wagering activity occurred on a platform for tracking activities at a casino, the present disclosure enables a user to undertake sporting event wagering activities on such a platform while remote from the casino and still availing themselves access to benefits. By offering benefits to individuals making sporting event wagers at partner establishments, the sporting event wagering system of the present disclosure promotes the placement of sporting event wagers while remote from a casino and further promotes user engagement at such partner establishments. As such, rather than requiring a user to travel to a casino to place one or more sporting event wagers on one or more sporting events and/or collect benefits earned for placing such sporting event wagers at the casino, the system of the present disclosure enables the user to place sporting event wagers from a partner establishment, such as a restaurant or bar, earn benefits for placing such sporting event wagers and collect the earned benefits, all without having to travel to a casino location. In other words, to extend the reach of a loyalty program for sporting event wagering activities undertaken at a specific location, the system operates to offer benefits to users, such as comps and/or discounts for goods and/or services purchased at the location, based on such sporting event wagering activities.

It should be further appreciated that any functionality or process of the present disclosure may be implemented via one or more servers (associated with or independent of any component of any system disclosed herein), one or more non-gaming establishment devices (e.g., a point-of-sale terminal of a retailer located external to and independent of a gaming establishment), a mobile device application, and/or one or more gaming devices (e.g., an EGM). Accordingly: (i) while certain functions, features or processes are described herein as being performed by a non-gaming establishment device, such functions, features or processes may alternatively be performed by one or more servers, or one or more mobile device applications, and/or one or more gaming devices, and (ii) while certain functions, features or processes are described herein as being performed by one or more servers (e.g., a server of a sporting event wagering system, a server of a retailer system, and/or a server of a point-of-sale system), such functions, features or processes may alternatively be performed by one or more gaming devices, one or more non-gaming establishment devices, or one or more mobile device applications.

In certain embodiments, the above-described embodiments of the present disclosure may be implemented in accordance with or in conjunction with zero, one or more components of a sporting event wagering system; zero, one or more components of a point-of-sale system; and/or zero, one or more non-gaming establishment devices. In these embodiments, such components of the sporting event wagering system, the retailer system, the point-of-sale system and/or the non-gaming establishment device each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the sporting event wagering system, the component of the retailer system, the component of the point-of-sale system and/or the non-gaming establishment device; (3) accessing memory to configure or reconfigure parameters in the memory according to indicia read from the component of the sporting event wagering system, the component of the retailer system, the component of the point-of-sale system and/or the non-gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the sporting event wagering system, the component of the retailer system, the component of the point-of-sale system and/or the non-gaming establishment device, while in other embodiments, at least one component of the controller resides outside of the housing of the component of the sporting event wagering system, the component of the retailer system, the component of the point-of-sale system and/or the non-gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the sporting event wagering system, the component of the retailer system, the component of the point-of-sale system and/or the non-gaming establishment device disclosed herein. In certain embodiments, the at least one memory device resides within the housing of the component of the sporting event wagering system, the component of the retailer system, the component of the point-of-sale system and/or the non-gaming establishment device, while in other embodiments at least one component of the at least one memory device resides outside of the housing of the component of the sporting event wagering system, the component of the retailer system, the component of the point-of-sale system and/or the non-gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the sporting event wagering system, the component of the retailer system, the component of the point-of-sale system and/or the non-gaming establishment device; (2) associations between configuration indicia read from the component of the sporting event wagering system, the component of the retailer system, the component of the point-of-sale system and/or the non-gaming establishment device with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the sporting event wagering system, the component of the retailer system, the component of the point-of-sale system and/or the non-gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the sporting event wagering system, the component of the retailer system, the component of the point-of-sale system and/or the non-gaming establishment device to control the component of the sporting event wagering system, the component of the retailer system, the component of the point-of-sale system and/or the non-gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a retail patron uses such a removable memory device in a component of the sporting event wagering system to implement at least part of the present disclosure. In other embodiments, part or all of the program code and/or the operating data is downloaded to the at least one memory device of the component of the sporting event wagering system, the component of the retailer system, the component of the point-of-sale system and/or the non-gaming establishment device through any suitable data network described above (such as an Internet or intranet).

The at least one memory device also stores a plurality of device drivers. Examples of different types of device drivers include device drivers for the component of the sporting event wagering system, the component of the retailer system, the component of the point-of-sale system and/or the non-gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the sporting event wagering system, the component of the retailer system, the component of the point-of-sale system and/or the non-gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In certain embodiments, when one type of a particular device is exchanged for another type of the particular device, the at least one processor of the component of the sporting event wagering system, the component of the retailer system, the component of the point-of-sale system and/or the non-gaming establishment device loads the new device driver from the at least one memory device to enable communication with the new device. For instance, one type of card reader in the component of the sporting event wagering system, the component of the retailer system, the component of the point-of-sale system and/or the non-gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the component of the sporting event wagering system, the component of the retailer system, the component of the point-of-sale system and/or the non-gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the sporting event wagering system, the component of the retailer system, the component of the point-of-sale system and/or the non-gaming establishment device. In various embodiments, the display devices serve as digital glass configured to aspects of the gaming establishment in which the component of the sporting event wagering system, the component of the retailer system, the component of the point-of-sale system and/or the non-gaming establishment device is located. In various embodiments, the component of the sporting event wagering system, the component of the retailer system, the component of the point-of-sale system and/or the non-gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. In these embodiments, after the component of the sporting event wagering system, the component of the retailer system, the component of the point-of-sale system and/or the non-gaming establishment device receives an actuation, the component of the sporting event wagering system, the component of the retailer system, the component of the point-of-sale system and/or the non-gaming establishment device causes the payout device to provide a payment to the user. In certain embodiments, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user.

In certain embodiments, the at least one output device is a sound generating device controlled by one or more sound cards. In one such embodiment, the sound generating device includes one or more speakers or other sound generating hardware and/or software configured to generate sounds, such as by playing music. In another such embodiment, the component of the sporting event wagering system, the component of the retailer system, the component of the point-of-sale system and/or the non-gaming establishment device provides dynamic sounds coupled with attractive multimedia images displayed on one or more of the display devices to provide an audio-visual representation or to otherwise display full-motion video with sound to attract users to the component of the sporting event wagering system, the component of the retailer system, the component of the point-of-sale system and/or the non-gaming establishment device. In certain embodiments, the component of the sporting event wagering system, the component of the retailer system, the component of the point-of-sale system and/or the non-gaming establishment device displays a sequence of audio and/or visual attraction messages during idle periods to attract potential users to the component of the sporting event wagering system, the component of the retailer system, the component of the point-of-sale system and/or the non-gaming establishment device. The videos may be customized to provide any appropriate information.

The at least one input device may include any suitable device that enables an input signal to be produced and received by the at least one processor of the component of the sporting event wagering system, the component of the retailer system, the component of the point-of-sale system and/or the non-gaming establishment device. In certain embodiments, the at least one input device includes a payment device configured to communicate with the at least one processor of the component of the sporting event wagering system, the component of the retailer system, the component of the point-of-sale system and/or the non-gaming establishment device to fund the component of the sporting event wagering system, the component of the retailer system, the component of the point-of-sale system and/or the non-gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In certain embodiments, the at least one input device includes a payment device configured to enable the component of the sporting event wagering system, the component of the retailer system, the component of the point-of-sale system and/or the non-gaming establishment device to be funded via an electronic funds transfer, such as a transfer of funds from a bank account. In another embodiment, the component of the sporting event wagering system, the component of the retailer system, the component of the point-of-sale system and/or the non-gaming establishment device includes a payment device configured to communicate with a mobile device of a user, such as a mobile phone, a radio frequency identification tag, or any other suitable wired or wireless device, to retrieve relevant information associated with that user to fund the component of the sporting event wagering system, the component of the retailer system, the component of the point-of-sale system and/or the non-gaming establishment device. When the component of the sporting event wagering system, the component of the retailer system, the component of the point-of-sale system and/or the non-gaming establishment device is funded, the at least one processor determines the amount of funds entered and displays the corresponding amount.

In various embodiments, the at least one input device includes a plurality of buttons that are programmable by the component of the sporting event wagering system, the component of the retailer system, the component of the point-of-sale system and/or the non-gaming establishment device operator to, when actuated, cause the component of the sporting event wagering system, the component of the retailer system, the component of the point-of-sale system and/or the non-gaming establishment device to perform particular functions. For instance, such buttons may be hard keys, programmable soft keys, or icons icon displayed on a display device of the component of the sporting event wagering system, the component of the retailer system, the component of the point-of-sale system and/or the non-gaming establishment device that are actuatable via a touch screen of the component of the sporting event wagering system, the component of the retailer system, the component of the point-of-sale system and/or the non-gaming establishment device or via use of a suitable input device of the component of the sporting event wagering system, the component of the retailer system, the component of the point-of-sale system and/or the non-gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the component of the sporting event wagering system, the component of the retailer system, the component of the point-of-sale system and/or the non-gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in certain embodiments, the at least one power distribution component includes a magnetic induction system that is configured to provide wireless power to one or more user input devices near the component of the sporting event wagering system, the component of the retailer system, the component of the point-of-sale system and/or the non-gaming establishment device. In certain embodiments, a user input device docking region is provided, and includes a power distribution component that is configured to recharge a user input device without requiring metal-to-metal contact. In certain embodiments, the at least one power distribution component is configured to distribute power to one or more internal components of the component of the sporting event wagering system, the component of the retailer system, the component of the point-of-sale system and/or the non-gaming establishment device, such as one or more rechargeable power sources (e.g., rechargeable batteries) located at the component of the sporting event wagering system, the component of the retailer system, the component of the point-of-sale system and/or the non-gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the sporting event wagering system, the component of the retailer system, the component of the point-of-sale system and/or the non-gaming establishment device; detecting the presence and/or identity of various persons (e.g., users, casino employees, etc.), devices (e.g., user input devices), and/or systems within a predetermined proximity to the component of the sporting event wagering system, the component of the retailer system, the component of the point-of-sale system and/or the non-gaming establishment device.

The at least one data preservation component is configured to detect or sense one or more events and/or conditions that, for example, may result in damage to the component of the sporting event wagering system, the component of the retailer system, the component of the point-of-sale system and/or the non-gaming establishment device and/or that may result in loss of information associated with the component of the sporting event wagering system, the component of the retailer system, the component of the point-of-sale system and/or the non-gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected user movements and/or gestures to determine appropriate user input information relating to the detected user movements and/or gestures. For example, in certain embodiments, the at least one motion/gesture analysis and interpretation component is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source enables the component of the sporting event wagering system, the component of the retailer system, the component of the point-of-sale system and/or the non-gaming establishment device to operate in a mobile environment.

The at least one geolocation module is configured to acquire geolocation information from one or more remote sources and use the acquired geolocation information to determine information relating to a relative and/or absolute position of the component of the sporting event wagering system, the component of the retailer system, the component of the point-of-sale system and/or the non-gaming establishment device. For example, in one implementation, the at least one geolocation module is configured to receive GPS signal information for use in determining the position or location of the component of the sporting event wagering system, the component of the retailer system, the component of the point-of-sale system and/or the non-gaming establishment device. In another implementation, the at least one geolocation module is configured to receive multiple wireless signals from multiple remote devices (e.g., component of the sporting event wagering system, the point-of-sale system and/or the gaming establishment devices, servers, wireless access points, etc.) and use the signal information to compute position/location information relating to the position or location of the component of the sporting event wagering system, the component of the retailer system, the component of the point-of-sale system and/or the non-gaming establishment device.

The at least one user identification module is configured to determine the identity of the current user or current owner of the component of the sporting event wagering system, the component of the retailer system, the component of the point-of-sale system and/or the non-gaming establishment device. For example, in certain embodiments, the current user is required to perform a login process at the component of the sporting event wagering system, the component of the retailer system, the component of the point-of-sale system and/or the non-gaming establishment device in order to access one or more features. Alternatively, the component of the sporting event wagering system, the component of the retailer system, the component of the point-of-sale system and/or the non-gaming establishment device is configured to automatically determine the identity of the current user based on one or more external signals, such as an RFID tag or badge worn by the current user and that provides a wireless signal to the component of the sporting event wagering system, the component of the retailer system, the component of the point-of-sale system and/or the non-gaming establishment device that is used to determine the identity of the current user. In at least certain embodiments, various security features are incorporated into the component of the sporting event wagering system, the component of the retailer system, the component of the point-of-sale system and/or the non-gaming establishment device to prevent unauthorized users from accessing confidential or sensitive information.

The at least one information filtering module is configured to perform filtering (e.g., based on specified criteria) of selected information to be displayed at one or more displays of the component of the sporting event wagering system, the component of the retailer system, the component of the point-of-sale system and/or the non-gaming establishment device.

In various embodiments, the component of the sporting event wagering system, the component of the retailer system, the component of the point-of-sale system and/or the non-gaming establishment device includes a plurality of communication ports configured to enable the at least one processor of the component of the sporting event wagering system, the component of the retailer system, the component of the point-of-sale system and/or the non-gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the component of the sporting event wagering system, the component of the retailer system, the component of the point-of-sale system and/or the non-gaming establishment device has a support structure, housing, or cabinet that provides support for a plurality of the input devices and the output devices of the component of the sporting event wagering system, the component of the retailer system, the component of the point-of-sale system and/or the non-gaming establishment device.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

1. A system comprising:
a processor; and
a memory device that stores a plurality of instructions that, when executed by the processor responsive to a receipt of data for a purchase transaction initiated at a point-of-sale terminal operating independent of the processor and associated with a retail establishment that is independent of any gaming establishment, cause the processor to:
responsive to a determination to authorize the purchase transaction based on an application of a first benefit earned from a first amount of sporting event wagering activity that occurred at the retail establishment in association with a server of a sporting event wagering system operating independent of the processor:
designate the first benefit as at least partially redeemed, and
communicate authorization data to the point-of-sale terminal to complete the purchase transaction without any additional forms of payment, and responsive to a determination to authorize part of the purchase transaction based on an application of a second benefit earned from a second amount of sporting event wagering activity that occurred at the retail establishment in association with the server of the sporting event wagering system:
designate the second benefit as redeemed, and
communicate partial authorization data to the point-of-sale terminal to reduce, based on the second benefit, a purchase price associated with the purchase transaction.

2. The system of claim 1, wherein the first benefit is associated with a first amount of retail establishment loyalty points maintained in a retail establishment loyalty account independent of any gaming establishment account and the second benefit is associated with a second, lesser amount of retail establishment loyalty points maintained in the retail establishment loyalty account.

3. The system of claim 2, wherein the retail establishment loyalty account is maintained independent of any other retail establishments.

4. The system of claim 1, wherein the first amount of sporting event wagering activity occurred in association with a first patron having a first status, the second amount of sporting event wagering activity occurred in association with a second, different patron having a second, different status and the first amount of sporting event wagering activity and the second amount of sporting event wagering activity are the same amount of sporting event wagering activity.

5. The system of claim 1, wherein responsive to the determination to authorize part of the purchase transaction based on the application of the second benefit earned from the second amount of sporting event wagering activity that occurred at the retail establishment, the purchase transaction is completable with an additional form of payment.

6. The system of claim 5, wherein the additional form of payment comprises a redemption of a third benefit.

7. The system of claim 1, wherein at least one of the first benefit and the second benefit is associated with at least one of the purchase price and a tier of a purchase transactions.

8. The system of claim 1, wherein the memory device stores a plurality of further instructions that, when executed by the processor responsive to the determination to authorize the purchase transaction based on the application of the first benefit, cause the processor to allocate at least a portion of the purchase price to an account associated with the retail establishment.

9. The system of claim 1, wherein at least one of the first amount of sporting event wagering activity and the second amount of sporting event wagering activity occurred at the retail establishment in association with a mobile device executing a mobile device application.

10.-11. (canceled)

12. A method of operating a system, the method comprising:
responsive to a receipt of data for a purchase transaction initiated at a point-of-sale terminal, operating independent of a processor of the system, associated with a retail establishment that is independent of any gaming establishment, and a determination to authorize the purchase transaction based on an application of a first benefit earned from a first amount of sporting event wagering activity that occurred at the retail establishment in association with a server of a sporting event wagering system operating independent of the processor of the system:
designating, by a processor, the first benefit as at least partially redeemed, and
communicating authorization data to the point-of-sale terminal to complete the purchase transaction without any additional forms of payment, and
responsive to the receipt of data for the purchase transaction initiated at the point-of-sale terminal associated with the retail establishment and a determination to authorize part of the purchase transaction based on an application of a second benefit earned from a second amount of sporting event wagering activity that occurred at the retail establishment in association with the server of the sporting event wagering system:
designating, by the processor, the second benefit as redeemed, and
communicating partial authorization data to the point-of-sale terminal to reduce, based on the second benefit, a purchase price associated with the purchase transaction.

13. The method of claim 12, wherein the first benefit is associated with a first amount of retail establishment loyalty points maintained in a retail establishment loyalty account independent of any gaming establishment account and the second benefit is associated with a second, lesser amount of retail establishment loyalty points maintained in the retail establishment loyalty account.

14. The method of claim 13, wherein the retail establishment loyalty account is maintained independent of any other retail establishments.

15. The method of claim 12, wherein the first amount of sporting event wagering activity occurred in association with a first patron having a first status, the second amount of sporting event wagering activity occurred in association with a second, different patron having a second, different status and the first amount of sporting event wagering activity and the second amount of sporting event wagering activity are the same amount of sporting event wagering activity.

16. The method of claim 12, wherein responsive to the determination to authorize part of the purchase transaction based on the application of the second benefit earned from the second amount of sporting event wagering activity that occurred at the retail establishment, the purchase transaction is completable with an additional form of payment.

17. The method of claim 16, wherein the additional form of payment comprises a redemption of a third benefit.

18. The method of claim 12, wherein at least one of the first benefit and the second benefit is associated with at least one of the purchase price and a tier of a purchase transactions.

19. The method of claim 12, further comprising, responsive to the determination to authorize the purchase transaction based on the application of the first benefit, allocating, by the processor, at least a portion of the purchase price to an account associated with the retail establishment.

20. The method of claim 12, wherein at least one of the first amount of sporting event wagering activity and the second amount of sporting event wagering activity occurred at the retail establishment in association with a mobile device executing a mobile device application.
